(19) United States
(12) Patent Application Publication
(10) Pub. No.: US 2008/0279202 A1
(43) Pub. Date: Nov. 13, 2008

(54) Integrated Gateway for Distributed Home Network and Software Framework Structure for the Same

(76) Inventors: Hyun Woo Choi, Gyeonggi-do (KR); Hwang Eui Lee, Incheon (KR); Dae Woo Park, Incheon (KR); Ho Young Jeon, Seoul (KR)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 12/093,286

(22) PCT Filed: Apr. 24, 2006
(86) PCT No.: PCT/KR2006/001536

§ 371 Date: May 9, 2008

(30) Foreign Application Priority Data
Nov. 18, 2005 (KR) 10-2005-0110765

(51) Int. Cl. H04L 12/66

(52) U.S. Cl. 370/401; 455/41.2

(57) ABSTRACT

Disclosed herein are an integrated gateway for a distributed home network and a software framework structure for the same. The integrated gateway includes an input/output interface unit (110), an Internet gateway unit (120), a telephone network interface/unit (130), a microprocessor (140), a control unit (150), a Universal Asynchronous Receiver/Transmitter (UART) (160), and a memory unit (170). The input/output interface unit (110) communicates with the home appliances. The Internet gateway unit (120) is connected to the Internet. The telephone network interface unit (130) is connected to the PSTN. The microprocessor (140) processes data transmitted and received through the Internet gateway unit (120) and a telephone network interface unit (130). The control unit (150) informs the microprocessor of interrupts and outputs control signals for controlling the transmission and reception of data according to the interrupts. The UART (160) controls the transmission and reception of data between the microprocessor (140) and the input/output interface unit (110)in response to the control signals. The memory unit (170) stores log information about the currently set status of devices and the transmission and reception of data.

### TECHNICAL FIELD

The present invention relates, in general, to an integrated gateway for a distributed home network and a software framework structure for the same and, more particularly, to an integrated gateway for a distributed home network and a software framework structure for the same, which provide a framework structure capable of integrating wired and wireless protocols that can be used for a home automation system, and allow each of the wired and wireless protocols to work in conjunction with an external network protocol through a gateway using the framework structure, so that various home appliances can be controlled from an external network through a single integrated gateway, therefore the implementation and maintenance of a home network can be facilitated and compatibility between the home appliances and the gateway can be maximized.

### BACKGROUND ART

Generally, a home network system refers to a physical network technology that connects all electric and electronic products, which are used at home, into a single wired or wireless system and can control the products regardless of time and place. The home network system automatically controls functions of information exchange through the transmission and reception of data between home appliances, monitoring, and security, as well as a simple function of remotely controlling the home appliances.

The home network system is connected to the Internet or a Wide Area Network (WAN) and enables external remote control. The home gateway plays the role of connecting an external network, such as the Internet or the WAN, with a home network.

The home gateway functions as an interface that allows the external network and the home network to smoothly work in conjunction with each other, and supports independence of respective communication network technologies.

Meanwhile, a home automation system is used to connect various home appliances, which is installed in a home, in a wired and wireless manner and enable more convenient control and management thereof, and employs a wired protocol, such as Power Line Communication (PLC) or Recommended Standard (RS)-485, and a wireless protocol, such as Radio Frequency (RF) or ZigBee.

Accordingly, the home gateway system performs management using an external network protocol, such as Transmission Control Protocol (TCP)/Internet Protocol (IP), and the wired or wireless protocol of the home automation system, thereby remotely controlling and monitoring the home automation system.

In other words, the technology of remotely controlling and monitoring the home network system, in which the home gateway technology and the home automation technology work in conjunction with each other, enables access to a home automation system in a home from a remote place over the Internet or a WAN, and the checking and controlling of the status of various home appliances.

However, the wired and wireless protocols of the home automation system do not work in conjunction with each other due to differences between respective protocols, so that only a single communication protocol-based home automation system is provided.

Accordingly, a problem occurs in that various home appliances installed in a home must be replaced with home appliances that use the same protocol, or different gateways must be installed and managed in the case where the home appliances use different protocols.

That is, the above-described home network system has a limitation in remotely controlling and monitoring all of the various home appliances.

### DISCLOSURE OF INVENTION

### Technical Problem

Accordingly, the present invention has been made keeping in mind the above problems occurring in the prior art, and an object of the present invention is to provide an integrated gateway for a distributed home network and a software framework structure for the same, which provide a framework structure capable of integrating wired and wireless protocols that can be used for a home automation system, and allow each of the wired and wireless protocols to work in conjunction with an external network protocol through a gateway using the framework structure, thus controlling various home appliances from an external network through a single integrated gateway.

That is, an object of the present invention is to provide an integrated gateway for a distributed home network and a software framework structure for the same, which integrate a wireless protocol, such as RF or ZigBee, and a wired protocol, such as RS-485 or PLC, which are used in home automation systems, into a single platform, thus enabling the control of home appliances from a remote place through the wired/wireless Internet and a Public Switched Telephone Network (PSTN).

Another object of the present invention is to provide an integrated gateway for a distributed home network and a software framework structure for the same, which improve the convenience of use, thus improving the commercial value.

### Technical Solution

In order to accomplish the above objects, the present invention provides an integrated gateway for a distributed home network in a home network system, the home network system connecting to a home gateway through an Internet and a PSTN using a client, and controlling home appliances using a home communication means, the integrated gateway including: an input/output interface unit for communicating with the home appliances using the protocol interface of the home communication means; an Internet gateway unit connected to the Internet to perform data communication; a telephone network interface unit connected to the PSTN to perform data communication; a microprocessor for processing data transmitted and received through the Internet gateway unit and a telephone network interface unit; a control unit for informing the microprocessor of interrupts generated by the input/output interface unit, the Internet gateway unit and the telephone network interface unit, and outputting control signals for controlling the transmission and reception of data, which is processed by the microprocessor, according to the interrupts; a Universal Asynchronous Receiver/Transmitter (UART) for controlling the transmission and reception of data between the microprocessor and the input/output interface unit in response to the control signals output from the control unit; and a memory unit for storing log information about the currently set status of devices and the transmission and reception of data.

In addition, the present invention provides a software framework structure for an integrated gateway for a distributed home network, including: a data network usage agent for performing control on a WAN or a Local Area Network (LAN), which uses Ethernet, through an Internet gateway unit, and managing service that can be provided through the WAN and the LAN; a telephone network usage agent for providing an ARS function through a telephone network interface unit, and remotely controlling and managing home appliances, at a request from the PSTN; a status management agent for managing log information about the currently set status of devices and transmitted and received data, which has been stored in a memory unit; a control network abstraction framework for performing a plug-in function for an input/output interface unit, and performing a common service interface function for an upper class application agent; a home automation service framework for providing an interface with the control network abstraction framework; and a message service framework functioning as a core interface to allow the agents and framework components to efficiently work in conjunction with each other.

### Advantageous Effects

The present invention provides a framework structure capable of integrating wired and wireless protocols that can be used for a home automation system, and integrally manages the protocols, which are used by various home appliances installed in a home, using a gateway based on the framework structure, so that the existing previously installed home appliances can be controlled through a single gateway without replacement of the home appliances, therefore the implementation and maintenance of a home network can be facilitated and compatibility between the home appliances and the gateway can be maximized.

Furthermore, a home network software developer can more easily develop software using the software framework structure according to the present invention.

Furthermore, the convenience of use is improved, so that the commercial value is increased.

### BRIEF DESCRIPTION OF THE DRAWINGS

FIG. 1 is a block diagram showing the construction of a distributed home network system according to the present invention;

FIG. 2 is a block diagram showing the construction of an integrated gateway for a distributed home network according to the present invention;

FIG. 3 is a block diagram showing the construction of a microprocessor shown in FIG. 2;

FIG. 4 is a block diagram showing the structure of a software framework for the operation of the integrated gateway according to the present invention; and

FIG. 5 is a block diagram showing the internal structure of the control network abstraction framework shown in FIG. 4.

### BEST MODE FOR CARRYING OUT THE INVENTION

Preferred embodiments of the present invention are described in detail with reference to the accompanying drawings below.

FIG. 1 is a block diagram showing the construction of a distributed home network system according to the present invention. A user connects to a home gateway 100 via the Internet 300 and the PSTN 400 using a Personal Computer (PC) 210, a mobile terminal 220, such as a mobile phone or Personal Digital assistant (PDA), or a general telephone 230, and then controls home appliances using a home communication means 500.

In this case, a Wireless Application Protocol (WAP) 310 is used to connect to the Internet 300 through the mobile terminal 220, and a wireless telephone network 410 is used to connect to the PSTN 400 through the mobile terminal 220.

Furthermore, the Internet 300 communicates with the gateway 100 through a modem 320.

Furthermore, the home communication means 500 includes a LAN device, a TCP/IP device, a ZigBee device, an RF device, an RS-485 device, a PLC device, and a home telephone network, and may be variously constructed according to the wishes of those skilled in the art.

FIG. 2 is a block diagram showing the construction of an integrated gateway for a distributed home network according to the present invention. The integrated gateway includes an input/output interface unit 110, an Internet gateway unit 120, a telephone network interface unit 130, a microprocessor 140, a control unit 150, a UART 160, and a memory unit 170.

Furthermore, home devices using the home communication means 500 for data communication include a wired home terminal 410 and a home wireless terminal 420, such as notebook computers or PCs, a ZigBee device 430, such as a digital door lock and sensor, an RF device 440, such as an RF remote controller and RF switch, an RS-485 device 450, such as a boiler and room controller, a PLC device 460, such as a PLC electric outlet and PLC switch, and a home telephone 470.

The input/output interface unit 110 communicates with home appliances using the protocol interface of the home communication means 500, and includes an RF interface unit 111 connected with the RF device 440, a ZigBee interface unit 112 connected with the ZigBee device 430, an RS-485 interface unit 113 connected with the RS-485 device 450, a PLC interface unit 114 connected with the PLC device 460, a console serial port 115 connected with the home wireless terminal 420, and a Peripheral Component Interconnect (PCI) interface unit 116.

The Internet gateway unit 120 is connected to the Internet 300 to perform data communication, and includes a WAN 121 connected with the modem 320, and a LAN 122 connected with the wired home terminal 410.

The telephone network interface unit 130 is connected with the PSTN 400 to perform data communication, and includes an external telephone network 131 connected with the PSTN 400, and an internal telephone network 132 connected with the home telephone 470.

The microprocessor 140 processes data transmitted through the Internet gateway unit 120 and the telephone network interface unit 130, and enables communication based on different protocols by processing various protocols.

A framework for communication between the above-described protocols, which are different from each other, is described in detail below.

The control unit 150 informs the microprocessor 140 of interrupts generated by the input/output interface unit 110, the Internet gateway unit 120, and the telephone network interface unit 130, outputs control signals for controlling the transmission and reception of data, which is processed by the microprocessor 140, according to the interrupts, and includes an interrupt processing unit 151 and a control signal processing unit 152. The method of transmitting and receiving data in response to the interrupts may be variously modified according to the wishes of those skilled in the art.

The UART 160 transmits and receives data between the microprocessor 140 and the input/output interface unit 110 in an asynchronous manner in response to the control signals output by the control unit 150, converts serial data into parallel data at the time of transmission, and converts parallel data into serial data at the time of reception.

The memory unit 170 stores log information about the currently set status of the respective devices and the transmission and reception of data, and may include various memories, such as main memory 171 and flash memory 172.

Furthermore, the gateway 100 may include a real time clock unit 101, a reset circuit unit 102, and a Joint Test Action Group (JTAG) debugging unit 103 so as to provide various additional functions according to the wishes of those skilled in the art.

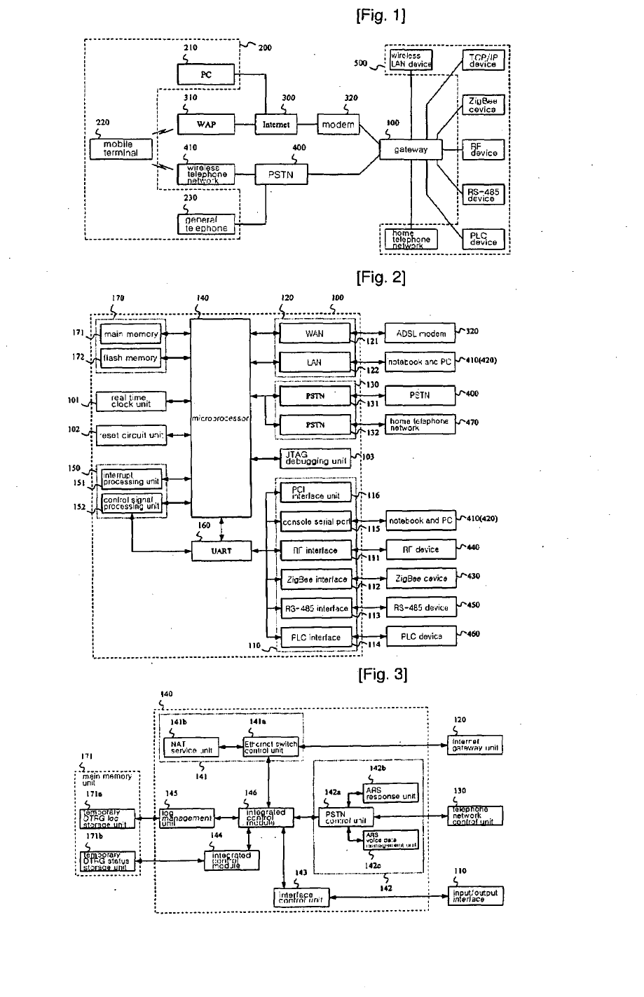

FIG. 3 is a block diagram showing the internal construction of the microprocessor 140. The microprocessor 140 includes an Ethernet switch unit 141, a telephone network control unit 142, an interface control unit 143, a status management unit 144, a log management unit 145, and an integrated control module 146.

The Ethernet switch unit 141 controls the Internet gateway unit 12, and includes an Ethernet switch control unit 141a for controlling the Internet gateway unit 120 and a Network Address Translation (NAT) service unit 141b for supporting a Dynamic Host Configuration Protocol (DHCP), IP Routing, and IP Forwarding for Internet gateway service according to the control of the Ethernet switch control unit 141a.

The telephone network control unit 142 provides Automatic Response Service (ARS) through the telephone network interface unit 130, and includes a communication control unit 142a for controlling communication with the telephone network interface unit 130, an ARS response unit 142b and an ARS voice data management unit 142c.

When an ARS request is received through the telephone network interface unit 130, voice data is transmitted to a High-speed Serial (HSS) interface. Thereafter, when a user presses numbers, the ARS response unit 142b analyzes the pressed numbers, and transmits voice messages corresponding to the analyzed numbers through the ARS voice data management unit 142c or performs instructions corresponding to the analyzed numbers.

The interface control unit 143, which transmits and receives data through the input/output interface 110, transmits data to the input/output interface 110 through the UART 160.

The status management unit 144, which stores information about the status of the gateway and the devices in the memory unit 170 and manages the information, stores the status information in the temporary status storage unit 171b of the main memory unit 151. The log management unit 145, which stores log information about transmitted and received messages, Ethernet switching status and the response status of the ARS in the memory unit 170 and manages the information, stores the log information in the temporary log storage unit 171a of the main memory unit 171.

The integrated control module 146 controls the conversion and processing of data between the Ethernet switch unit 141, the telephone network control unit 142, the interface control unit 143, the status management unit 144, and the log management unit 145, and the transmission of resulting data.

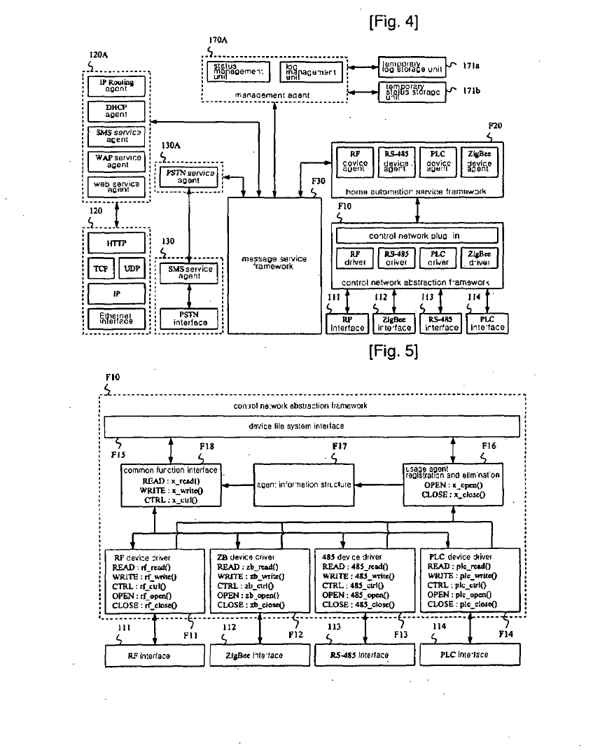

FIG. 4 is a block diagram showing the software framework structure for the operation of the integrated gateway according to the present invention. The software framework structure includes a data network usage agent 120A, a telephone network usage agent 130A, a status management agent 170A, a control network abstraction framework F10, a home automation service framework F20, and a message service framework F30.

The data network usage agent 120A performs control on a WAN or a LAN that uses the Ethernet through the Internet gateway unit 120, manages service that can be provided through the WAN and the LAN, and includes an IP routing agent, a DHCP agent, a Short message Service (SMS) service agent, a WAP service agent, and a web service agent.

The telephone network usage agent 130A provides an ARS function through the telephone network interface unit 130 at a request from the PSTN, and remotely controls and manages home appliances therethrough.

The status management agent 170A manages log information about currently set status of devices and transmission and reception of data, which has been stored in the memory unit 170, and includes a status management unit and a log management unit.

The control network abstraction framework F10 performs a plug-in function for an input/output interface unit 110, and performs a common service interface function for an upper class application agent, the detailed construction of which is described in detail below.

The home automation service framework F20 provides an interface with the control network abstraction framework F10, and includes an RF device agent, a ZigBee device agent, an RS-485 device agent, and a PCL device agent.

The message service framework F30 functions as a core interface to allow the agents and framework components to efficiently work in conjunction with each other, and includes a device manager, a message service manager, a status management manager, a user authentication manager, and a log manager, and allows the managers to control the agents and the framework and performs the transmission of data.

FIG. 5 is a block diagram showing the internal structure of the control network abstraction framework shown in FIG. 4. The control network abstraction framework includes an RF device driver F11, a ZigBee device driver F12, an RS-485 device driver F13, and a PLC device driver F14, which are connected with a lower class layer, and a device file system interface F15, an agent registration and elimination function F16, an agent information structure F17, and a common function interface F18, which are connected with an upper class agent layer.

The RF device driver F11, the ZigBee device driver F12, the RS-485 device driver F13, and the PLC device driver F14 are respectively connected with an RF interface 111, a ZigBee interface 112, an RS-485 interface 113, and a PLC interface 114, and each of the drivers has a READ function, a WRITE function and a CTRL function for controlling the input/output of data, and an OPEN function for performing agent registration, and a CLOSE function for performing agent elimination.

The agent registration and elimination function F16, which identifies the agent that gains access through the device file system interface F15 and registers a device driver corresponding to the agent, registers and eliminates the corresponding driver using the OPEN function and CLOSE function.

The agent information structure F17 registers information about an agent selected by the agent registration and elimination function F16. When the OPEN function of a corresponding device driver is executed by the agent registration and elimination function F16, the agent information structure F17 acquires information about the registration of the corresponding agent by the executed OPEN function.

Thereafter, the transmission and reception of data are performed by the registered agent.

In the case where it is desired to use another device driver, the agent registration and elimination function F16 executes the CLOSE function, eliminates information registered in the agent information structure F17, and executes the OPEN function of a desired device driver, thus allowing information about the registration of the corresponding agent to be registered in the agent information structure F17.

Accordingly, a desired device can be added or deleted by the plug-in function.

The common function interface F18 controls a device, which is connected to a corresponding interface, using the READ, WRITE, and CTRL functions according to information about agents that have been registered in the agent information structure F17.

That is, devices that are registered by the agent registration and elimination function F16 can be controlled by the common function interface F18, and the agent registration and elimination function F16 can selectively eliminate a desired device at the user's request.

### INDUSTRIAL APPLICABILITY

As described above, the present invention provides a framework structure capable of integrating wired and wireless protocols that can be used for a home automation system, and integrally manages the protocols, which are used by various home appliances installed in a home, using a gateway based on the framework structure, so that the existing previously installed home appliances can be controlled through a single gateway without replacement of the home appliances, therefore the implementation and maintenance of a home network can be facilitated and compatibility between the home appliances and the gateway can be maximized.

Furthermore, a home network software developer can more easily develop software using the software framework structure according to the present invention.

Accordingly, the present invention is very useful in that the convenience of use is improved, so that the commercial value is increased.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. An integrated gateway for a distributed home network in a home network system, the home network system connecting to a home gateway through an Internet and a Public Switched Telephone Network (PSTN) using a client, and controlling home appliances using home communication means, the integrated gateway comprising:
an input/output interface unit for communicating with the home appliances using a protocol interface of the home communication means;
an Internet gateway unit connected to the Internet to perform data communication;
a telephone network interface unit connected to the PSTN to perform data communication;
a microprocessor for processing data transmitted and received through the Internet gateway unit and a telephone network interface unit;
a control unit for informing the microprocessor of interrupts generated by the input/output interface unit, the Internet gateway unit and the telephone network interface unit, and outputting control signals for controlling transmission and reception of data, which is processed by the microprocessor, according to the interrupts;
a Universal Asynchronous Receiver/Transmitter (UART) for controlling transmission and reception of data between the microprocessor and the input/output interface unit in response to the control signals output from the control unit; and
a memory unit for storing log information about currently set status of devices and the transmission and reception of data.

2. The integrated gateway according to claim 1, wherein the microprocessor comprises:
an Ethernet switch unit for controlling the Internet gateway unit;
a telephone network control unit for providing Automatic Response Service (ARS) through the telephone network interface unit;
an interface control unit for transmitting and receiving data through the input/output interface;
a status management unit for storing and managing information about status of the gateway and the devices in the memory unit;
a log management for storing and managing log information about transmitted and received messages, Ethernet switching status and response status of the ARS in the memory unit; and
an integrated control module for controlling data transmission between the Ethernet switch unit, the telephone network control unit, the interface control unit, the status management unit, and the log management unit.

3. A software framework structure for an integrated gateway for a distributed home network, comprising:
a data network usage agent for performing control on a Wide Area Network (WAN) or a Local Area Network (LAN), which uses Ethernet, through an Internet gateway unit, and managing service that can be provided through the WAN and the LAN;
a telephone network usage agent for providing an ARS function through a telephone network interface unit, and remotely controlling and managing home appliances, at a request from the PSTN;
a status management agent for managing log information about currently set status of devices and transmitted and received data, which has been stored in a memory unit;
a control network abstraction framework for performing a plug-in function for an input/output interface unit, and performing a common service interface function for an upper class application agent;
a home automation service framework for providing an interface with the control network abstraction framework; and
a message service framework functioning as a core interface to allow the agents and framework components to efficiently work in conjunction with each other.

4. The software framework structure according to claim 3, wherein the control network abstraction framework comprises:
a Radio Frequency (RF) device driver connected with a RF interface;
a ZigBee device driver connected with a ZigBee interface layer;
a Recommended Standard (RS)-485 device driver connected with an RS-485 interface layer;
a Power Line Communication (PLC) device driver connected with a PLC interface layer;
a device file system interface connected with an upper class agent layer;
an agent registration and elimination function for identifying an agent that gains access through the device file system interface, and registering a device driver corresponding to the agent;
an agent information structure for registering information about an agent selected by the agent registration and elimination function agent; and
a common function interface for controlling a device, which is connected to a corresponding interface, according to the information about the agent, which is registered in the agent information structure.
